(19) United States
(12) Patent Application Publication
(10) Pub. No.: US 2024/0235303 A1
(43) Pub. Date: Jul. 11, 2024

(54) ROTOR FOR AN ELECTRIC MACHINE

(71) Applicants: Volkswagen Aktiengesellschaft, Wolfsburg (DE); AUDI Aktiengesellschaft, Ingolstadt (DE)

(72) Inventors: Sven PIEPER, Borchen (DE); Tim BACHMANN, Bad Emstal (DE); Stefan PROKOPH, Edermuende (DE); Moritz LUX, Muenchen (DE)

(73) Assignees: Volkswagen Aktiengesellschaft, Wolfsburg (DE); AUDI Aktiengesellschaft, Ingolstadt (DE)

(21) Appl. No.: 18/409,629

(22) Filed: Jan. 10, 2024

(30) Foreign Application Priority Data
Jan. 10, 2023 (DE) 10 2023 100 360.7

(51) Int. Cl. H02K 1/32; H02K 1/04; H02K 1/18

(52) U.S. Cl. CPC H02K 1/32; H02K 1/04; H02K 1/18

(57) ABSTRACT

A rotor for an electric machine including a rotor shaft and a core stack fastened thereto, at least one coolant outlet being provided at the axial end-face side of the core stack. For centrifugal cooling of the winding heads of the stator of the electric machine, a coolant conducting structure is provided at the axial core stack end-face side, via which the coolant exiting from the coolant outlet is spun off radially outwardly in the direction of the winding heads as the result of centrifugal force. The coolant conducting structure is designed as a single-material and/or one-piece integral part of the rotor, in particular the rotor core stack.

This nonprovisional application claims priority under 35 U.S.C. § 119(a) to German Patent Application No. 10 2023 100 360.7, which was filed in Germany on Jan. 10, 2023 and which is herein incorporated by reference.

### BACKGROUND OF THE INVENTION

### Field of the Invention

The invention relates to a rotor for an electric machine and to an electric machine.

### Description of the Background Art

A generic rotor for an electric machine is made up of a rotor shaft and a core stack fastened thereto. At least one coolant outlet is provided at the axial end-face side of the core stack. A coolant conducting structure is provided at the axial end-face side of the core stack for centrifugal cooling of the winding heads of the stator of the electric machine. The coolant exiting from the coolant outlet is spun off radially outwardly in the direction of the winding heads, via the coolant conducting structure, as the result of centrifugal force. In this way, heat generation in particular in the winding heads of the stator may be reduced.

In the prior art, the coolant conducting structure is formed by additional components such as coolant guide plates. This results in comparatively complex installation of the electric machine. In particular, fixing the coolant conducting structure to the rotor, which requires additional processes, is problematic. Coolant guide plates are often critical with regard to corrosion and electromagnetic compatibility and are affected by significant tolerances, which may result in large fluctuations in product quality.

An electric machine is known from US 2019/0273420 A1, which includes a coil end cover that is formed of an insulating material and is configured to cover at least an outer circumference of an upper region of the stator core. The circumference of an upper region of the coil end is covered. A liquid coolant passage through which a liquid coolant flows toward a coil end is provided in the coil end cover. A permanent magnet electric motor is known from DE 10 2020 132 112 A1, which corresponds to US 2021/0211012. The rotor shaft thereof defines a shell that is configured to accommodate a coolant. A cooling system for an electric motor is known from DE 10 2019 124 209 B4. An end disk of a rotor core stack has a first section in which the end disk has a conical design around the rotor shaft. The end disk is designed in such a way that an ejection of a coolant jet results in axial fanning out of the jet, and a radial inner side of the stator winding heads is uniformly wetted and cooled. A further electric machine is known from CN 110224551 A. All of the cited references being incorporated herein by reference.

### SUMMARY OF THE INVENTION

It is therefore an object of the invention to provide a rotor for an electric machine, in which the cooling of the electric machine may be carried out with a reduced component outlay and/or more efficiently compared to the prior art.

The invention is based on an electric machine that includes a stator housing at whose inner side a stator is fastened, the stator cooperating with a radially inner, rotatably supported rotor. Situated axially on each side of this rotor/stator arrangement is a winding head space into which the winding heads protrude from stator windings of the stator. The winding heads protrude beyond a core stack end-face side of the rotor with an overlength. The rotor is made up of a rotor shaft, and the above-mentioned rotor core stack which rotatably fixedly rests on the rotor shaft. At least one coolant outlet may be provided at the axial end-face side of the core stack. For centrifugal cooling of the winding heads of the stator, in addition a coolant conducting structure may be provided at the axial core stack end-face side, via which the coolant exiting from the coolant outlet is spun off radially outwardly in the direction of the winding heads as the result of centrifugal force. According to the characterizing portion of claim 1, the coolant conducting structure is no longer formed from separate additional components, and instead is designed as a single-material and/or one-piece integral part of the rotor, in particular the rotor core stack. Analogously, a coolant guide ring and/or a distributor housing, described below, may be designed as a single-material and/or one-piece integral part of the rotor, in particular the rotor core stack.

The present invention is applicable to a permanently excited electric machine as well as to an externally excited synchronous machine. For a permanently excited electric machine, the rotor core stack has magnet receptacles in which permanent magnets are situated. The permanent magnets may be fixed by means of a casting process in which a plastic casting compound is molded into the rotor core stack. Alternatively, for an application of the invention to an externally excited synchronous machine, the coolant conducting structure, the distributor housing described below, or the coolant guide ring may be molded on in one piece during casting of the rotor windings.

In an example, at least one coolant channel may pass through the rotor core stack in the axial direction. The coolant channel opens axially outwardly at the coolant outlet. The coolant conducting structure may be designed as a guide web, for example, that protrudes from the core stack end-face side with a profile height up to a spin-off edge. The coolant is spun off radially outwardly in the direction of the winding heads via the spin-off edge of the guide web. The guide web is situated radially outside the coolant outlet. In a first design variant, the guide web may be in radial alignment with the coolant outlet. Alternatively, in a second design variant the guide web may extend annularly around the rotor shaft.

The coolant conducting structure may be completely or at least partially formed from a plastic casting compound. This plastic casting compound may be molded onto the core stack end-face side. To increase the component strength, the coolant conducting structure may additionally include a reinforcing element that is at least partially encapsulated by the plastic casting compound. The forming of the coolant conducting structure may optionally be carried out completely independently of the casting process described below, in which magnet fixing takes place.

As indicated above, the rotor core stack may be subjected to a casting process in a process for manufacturing the rotor. In the casting process, the rotor core stack may be castable by use of a plastic casting compound. The casting tools in the casting process may preferably be designed in such a way that the coolant conducting structure is also molded onto the rotor core stack. Alternatively, the coolant conducting structure may be molded on in a separate casting process. Duroplastic materials such as those based on epoxy resin, or thermoplastics such as polyamide are suitable as casting compound.

For efficient cooling of the electric machine, the rotor may be connected to a coolant supply. The coolant supply may be used to supply the coolant, via a rotor shaft cross hole, across a flow path from a rotor shaft interior into an annular gap in the inner corner area, between the core stack end-face side and the rotor shaft. The annular gap is delimited with respect to the winding head space by a coolant guide ring.

In the further course, the flow path may lead from the annular gap, via radially inner, circumferentially distributed coolant channels, to the opposite second core stack end-face side. A ring-shaped distributor housing that surrounds the rotor shaft is situated at the opposite second core stack end-face side. The operating principle of the distributor housing is as follows: A portion of the coolant outlets of the radially inner coolant channels are exposed by the distributor housing for centrifugal cooling of the winding heads. In contrast, the distributor housing for the other portion of the coolant outlets of the radially inner coolant channels provides a flow connection to radially outer coolant channels, via which the coolant flows in the opposite flow direction back to the first core stack end-face side. The radially outer coolant channels thus act as return channels in which the coolant flows in the opposite flow direction back to the first core stack end-face side. Rotor cooling may be increased in this way.

It is preferred for the coolant outlet of the radially outer coolant channels (i.e., the return channels) to be exposed at the first core stack end-face side for centrifugal cooling of the winding heads. The coolant outlets of the radially outer coolant channels are situated at the first core stack end-face side, radially outside the coolant guide ring but radially inside the coolant conducting structure. In addition, the coolant guide ring, analogously to the coolant conducting structure, may be molded as a single material and/or as one piece onto the first core stack end-face side.

The molded-on air guide structure, the molded-on distributor housing, and/or the molded-on coolant guide ring may be designed with additional wing elements that protrude radially outwardly into the winding head space. By means of such wing elements the driven air may be deflected, and convection for the purpose of winding head cooling may thus be generated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1 through 7 show different views of the rotor, according to an example of the invention, of an electric machine.

### DETAILED DESCRIPTION

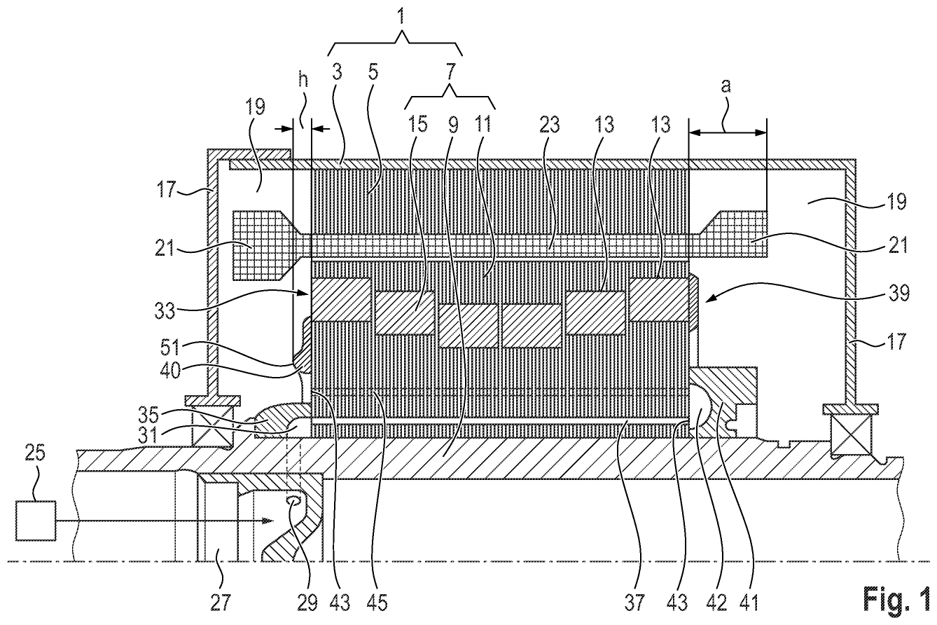

FIG. 1 shows a rough schematic illustration of an upper half of an electric machine 1, depicted to the extent necessary for understanding the invention. Accordingly, the electric machine 1 includes a hollow cylindrical stator housing 3, to the inner side of which a stator 5 is fastened. The stator 5 cooperates with a radially inner rotor 7 made up of a rotor shaft 9 and a rotor core stack 11 fastened thereto. In the figures, the electric machine 1 by way of example is a permanently excited synchronous machine in which the rotor core stack 11 has magnet receptacles 13 in which permanent magnets 15 are inserted. The permanent magnets are fixed in the magnet receptacles 13 by means of a plastic casting compound 40.

The rotor shaft 11 is rotatably supported in bearing openings at axially opposite housing walls 17 of the stator housing 3. Situated axially on each side of the rotor/stator arrangement, inside the stator housing 3, is a winding head space 19 into which the winding heads 21 of the stator windings 23 of the stator 5 protrude. The winding heads 21 protrude beyond the core stack end-face side 33, 39 of the rotor 7 with an overlength a (FIG. 1).

For cooling of the electric machine 1, the rotor 7 is connected to a coolant supply 25. The coolant supply 25 is used to supply the coolant, via a rotor shaft cross hole 29, across a flow path from a rotor shaft interior 27 into an annular gap 31 in the inner corner area, between a first core stack end-face side 33 (at the left in FIG. 1) and the rotor shaft 9. The annular gap 31 is delimited by a coolant guide ring 35. In the further course, the flow path leads from the annular gap 31, via radially inner, circumferentially distributed coolant channels 37, to the opposite second core stack end-face side 39. A ring-shaped distributor housing 41 that surrounds the rotor shaft 9 is situated at the second core stack end-face side 39 (at the right in FIG. 1).

With the aid of the ring-shaped distributor housing 41, the coolant outlets 43 of the radially inner coolant channels 37 in the circumferential direction are alternately either exposed for centrifugal cooling of the winding heads 21 (FIG. 7), described below, or brought into flow connection 42 with radially outer coolant channels 45 (FIG. 1), which are likewise formed in the core stack 11. The radially outer coolant channels 45 act as return channels via which the coolant flows in the opposite flow direction back to the first core stack end-face side 33. The coolant outlets 43 of the radially outer coolant channels 45 at the first core stack end-face side 33 are likewise axially outwardly exposed for centrifugal cooling of the winding heads 21.

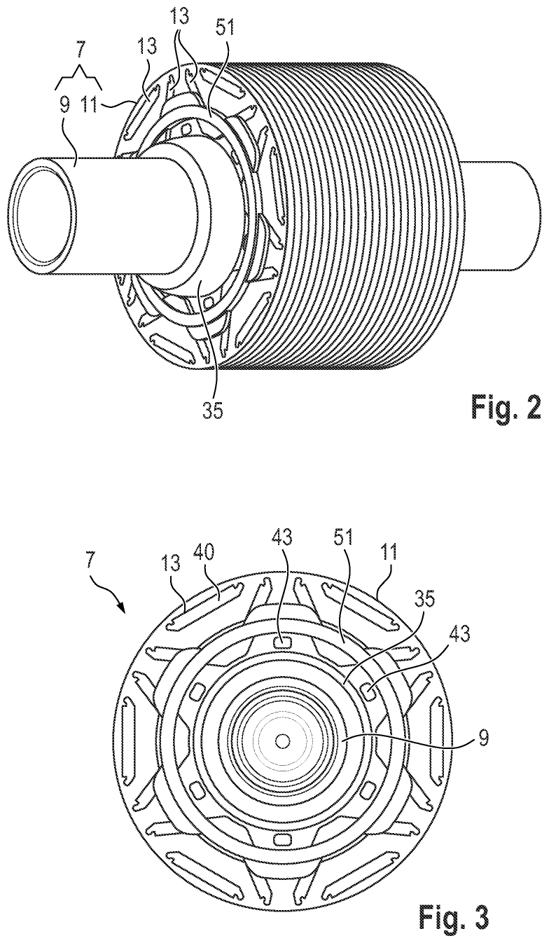

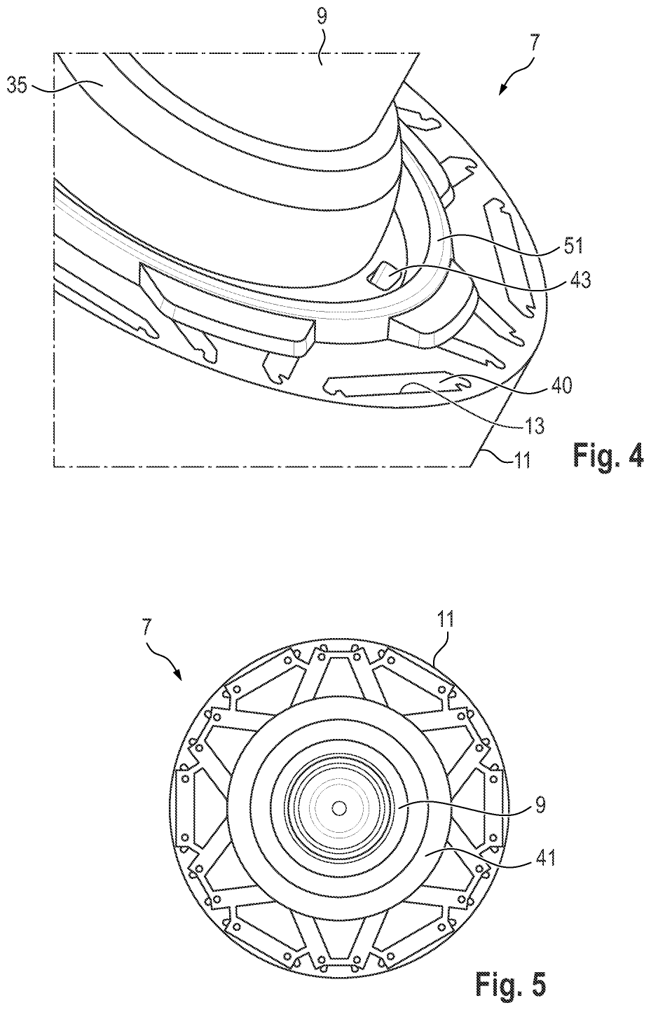

In order for the winding heads 21 to be acted on with coolant in a targeted manner during the centrifugal cooling, a coolant conducting structure 51 is provided at each of the two core stack end-face sides 33, 39. At the first core stack end-face side 33 (at the left in FIG. 1), the coolant conducting structure 51 is implemented as a ring-shaped guide web that surrounds the rotor shaft 7 with radial spacing. The ring-shaped guide web 51 is illustrated in detail in FIGS. 2, 3, and 4. The ring-shaped guide web 51 protrudes from the first core stack end-face side 33 with a profile height h (FIG. 1) up to a spin-off edge 49 (identified only in FIG. 7), via which the coolant is spun off radially outwardly in the direction of the winding heads 21. The ring-shaped guide web 51 is situated radially outside the coolant outlets 43 of the radially outer coolant channels 45 in FIGS. 1 through 4.

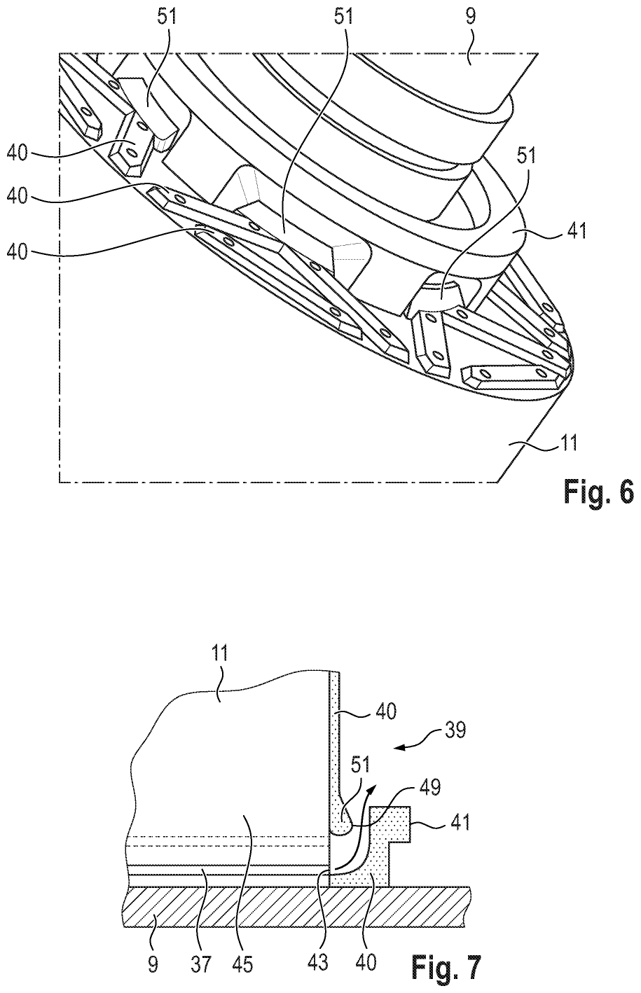

Similarly, a coolant conducting structure 51 is also molded onto the second core stack end-face side 39 (at the right in FIG. 1). However, this coolant conducting structure is not implemented as a ring-shaped guide web, but, rather, as a plurality of circumferentially distributed single guide webs, as is apparent from the detailed views in FIGS. 5, 6, and 7. Each of the single guide webs 51 is in radial alignment with the coolant outlets 43 of the radially inner coolant channels 37, which are exposed by the distributor housing 41 for centrifugal cooling of the winding heads 21.

During manufacture of the rotor 7, the rotor core stack 11 together with the permanent magnets 15 situated therein is cast in a casting process, using a plastic casting compound 40. In the present example, in the casting process the ring-shaped guide web 51 made of the plastic casting compound 40 is also molded onto the first core stack end-face side 33 of the rotor core stack 11 at the same time. In addition, the single guide webs 51 and/or the distributor housing 41 may optionally be molded onto the second core stack end-face side 39 (at the right in FIG. 1) during casting of the permanent magnets 15.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A rotor for an electric machine, the rotor comprising:
a rotor shaft; and
a core stack fastened to the rotor shaft; and
at least one coolant outlet being provided at an axial end-face side of the core stack,
a coolant conducting structure for centrifugal cooling of winding heads of a stator of the electric machine, the coolant conducting structure being provided at the axial core stack end-face side, via which the coolant exiting from the at least one coolant outlet is spun off radially outwardly in a direction of the winding heads as a result of centrifugal force,
wherein the coolant conducting structure is designed as a single-material and/or one-piece integral part of the rotor or the rotor core stack.

2. The rotor according to claim 1, wherein at least one coolant channel that opens axially outwardly at the coolant outlet passes through the rotor core stack in the axial direction, and/or wherein the coolant conducting structure is at least one guide web that protrudes from the core stack end-face side with a profile height up to a spin-off edge, via which the coolant is spun off radially outwardly in the direction of the winding heads.

3. The rotor according to claim 2, wherein the guide web is situated radially outside the coolant outlet, and/or wherein the guide web is in radial alignment with the coolant outlet or the guide web surrounds the rotor shaft in a continuous circle.

4. The rotor according to claim 1, wherein the coolant conducting structure is at least partially formed from a plastic casting compound that is molded onto the core stack end-face side, and wherein the coolant conducting structure additionally includes a reinforcing element that is at least partially encapsulated by the plastic casting compound.

5. The rotor according to claim 1, wherein, in a process for manufacturing the rotor, the rotor core stack is castable in a casting process by use of the plastic casting compound, and wherein, in the casting process, the coolant conducting structure is also molded onto the rotor core stack.

6. A rotor for an electric machine, the rotor comprising:
a rotor shaft; and
a core stack fastened to the rotor shaft;
a coolant supply, the rotor being connected to the coolant supply, which is used to supply coolant, via a rotor shaft cross hole, across a flow path from a rotor shaft interior into an annular gap in an inner corner area, between a first core stack end-face side and the rotor shaft, the annular gap being delimited by a coolant guide ring, the flow path leading from the annular gap, via radially inner, circumferentially distributed coolant channels, to an opposite second core stack end-face side; and
a ring-shaped distributor housing surrounding the rotor shaft is arranged at the opposite second core stack end-face side, the distributor housing exposing a portion of the coolant outlets of the radially inner coolant channels for centrifugal cooling of the winding heads,
wherein the distributor housing for the other portion of the coolant outlets of the radially inner coolant channels provides a flow connection to radially outer coolant channels, via which the coolant flows in an opposite flow direction back towards the first core stack end-face side.

7. The rotor according to claim 6, wherein the coolant outlets of the radially outer coolant channels are exposed at the first core stack end-face side for centrifugal cooling of the winding heads.

8. The rotor according to claim 7, wherein the coolant outlets of the radially outer coolant channels are arranged at the first core stack end-face side, radially outside the coolant guide ring.

9. The rotor according to claim 6, wherein the coolant guide ring and/or the ring-shaped distributor housing are molded as a single material and/or as one piece onto the first core stack end-face side.

10. An electric machine comprising:
a radially inner rotor according to claim 1; and
a stator housing at whose inner side a stator is fastened, the stator cooperating with the radially inner rotor,
wherein arranged axially on each side of the rotor/stator arrangement is a winding head space into which winding heads protrude from stator windings, the winding heads protruding beyond the core stack end-face side of the rotor with an overlength.
